(19) United States
(12) Patent Application Publication
(10) Pub. No.: US 2016/0204659 A1
(43) Pub. Date: Jul. 14, 2016

(54) POWER TRANSMISSION SHEET, POWER SUPPLY DEVICE AND POWER TRANSMISSION SYSTEM

(71) Applicant: SHOWA DENKO K.K., Tokyo (JP)

(72) Inventors: Yasuaki TAMINO, Tokyo (JP); Hiroshi KONUMA, Tokyo (JP); Ayako NISHIOKA, Tokyo (JP); Mitsuhiro IMAIZUMI, Tokyo (JP)

(73) Assignee: SHOWA DENKO K.K., Tokyo (JP)

(21) Appl. No.: 14/914,918

(22) PCT Filed: Jul. 25, 2014
(86) PCT No.: PCT/JP2014/069707

§ 371 Date: Feb. 26, 2016

(30) Foreign Application Priority Data
Aug. 30, 2013 (JP) 2013-180625

(51) Int. Cl. H02J 50/12

(52) U.S. Cl. CPC H02J 50/12

(57) ABSTRACT

The power transmission sheet (22) includes a base portion (225) adhered to the surface of a wall portion (50), transfers power by wireless power supply to a plug, and has a deformable shape. This power transmission sheet (22) is provided with: an electrode layer (222c) including electrodes (222a) and electrodes (222b) arranged in an array; a wiring portion (221) for transferring power to the electrodes (222a, 222b); a covering layer (223) formed on a surface opposite to the base portion (225) adhered on the wall portion (50) as viewed from the electrode layer (222c); and an attachable structure in which a plug can be attached such that the electrode surface provided on the plug confronts the electrodes (222a, 222b) with the covering layer (223) interposed therebetween.

### TECHNICAL FIELD

The present invention relates to, for example, a power transmission sheet, etc, that is used in performing wireless power supply by an electric field coupling method.

### BACKGROUND ART

In recent years, techniques for performing wireless power supply that transmits power without connecting cables to power consuming devices, such as portable equipment, have been widely spreading. As the system performing wireless power supply, various kinds of systems, such as an electromagnetic induction system, an electric field coupling method and a magnetic resonance system, have been suggested.

Of these, in a method according to the electric field coupling method, for example, respective electrodes provided to a power supply device side and a power consuming device side are caused to confront each other, and an AC voltage is applied to the electrode on the power supply device side, to thereby transfer an AC power by electrostatic induction generated between the electrodes.

In Patent Document 1, there is disclosed a power supply system for bathrooms that includes a power supply socket to supply power in a non-contact manner by electromagnetic induction, and connects the power supply socket to a power supply line drawn into a bathroom for an electric appliance already installed in a bathroom.

Moreover, in Patent Document 2, there is disclosed a non-contact power transfer device, in which an amplitude, a frequency, or a waveform of a voltage applied to a primary coil is varied depending on an inductance of the primary coil which varies according to variation of relative positional relationship between the primary coil and a secondary coil.

Further, in Patent Document 3, there is disclosed a building with non-contact power supply function, in which non-contact power supply portions for generating a high-frequency magnetic field are disposed inside each of a wall panel, a ceiling panel and a floor panel or rear surfaces of the panels of a building, and non-contact power receiving portions for supplying power to a DC apparatus by receiving the power from the power supply portions in a non-contact manner, by utilizing electromagnetic induction, based on the high-frequency magnetic field generated by the non-contact power supply portions are provided on positions opposing to the non-contact power supply portions in the surfaces of the panels, instead of outlets provided on the surfaces of the wall panel, the ceiling panel and the floor panel of the building and supplying power to a load by allowing a conductor electrically connected to the load to contact the load.

Still further, in Patent Document 4, there is disclosed a non-contact power supply system, in which plural non-contact power supply portions are disposed in a wall panel, a ceiling panel, a floor panel forming a wall, a ceiling, a floor of a building, a non-contact power receiving portion for supplying power received in a non-contact manner from the non-contact power supply portions to a DC apparatus is disposed at a location opposite to any one of the non-contact power supply portions on the surfaces of the panels; and a drive control portion is provided with a disposition detecting means for detecting that the non-contact power receiving portion is disposed to face the corresponding non-contact power supply portion, if an impedance when viewing the power reception side from the non-contact power supply portion changes at a predetermined pattern.

Still further, in Patent Document 5, there is disclosed a non-contact power supply adapter, in which the non-contact power supply adapter is attached on the front surface of a panel oppositely to a non-contact power supply portion disposed on a position standardized in the panel configuring a wall, a ceiling or a floor of a building or on the rear surface of the panel and for generating a standardized high-frequency magnetic field. The adapter is provided with magnets as an attaching means detachably attached on the front surface of the panel oppositely to the non-contact power supply portion; a non-contact power receiving portion, having a standardized relative position with the non-contact power supply portion and receiving power in a non-contact manner from the non-contact power supply portion, by utilizing electromagnetic induction on a high-frequency magnetic field generated by the non-contact power supply portion; a recess for attaching an electrical apparatus; and a power supply portion for supplying the received power to the electrical apparatus attached in the recess via a power supply terminal.

Still further, in Patent Document 6, there is disclosed a power supplying socket including a socket and a plug, in which the socket includes two power supplying terminals and a primary coil, and the plug includes two power receiving terminals coming into contact with the power supplying terminals, and a secondary coil electromagnetically coupling with the primary coil. The two power supplying terminals and the two power receiving terminals come into contact with each other to supply electric power from the socket to the plug by the contact power supplying, and the primary coil and second coil electromagnetically couple with each other to supply electric power from the socket to the plug by the non-contact power supplying.

Still further, in Patent Document 7, there is disclosed a furniture, in which a power supply part is fixed to the rear surface side of a top plate to supply power to a power reception part of an electronic apparatus placed on a surface of the top plate in a non-contact manner. In the furniture, a thin wall part is formed at a part of the top plate and the power supply part is disposed below the thin wall part and is fixed to a rear surface of the top plate by a fixing member disposed so as to lie astride the power supply part and the rear surface of the top plate.

### CITATION LIST

### Patent Literature

Patent Document 1: Japanese Patent Application Laid-Open Publication No. 2000-341886

Patent Document 2: Japanese Patent Application Laid-Open Publication (Translation of PCT Application) No. 2002-101578

Patent Document 3: Japanese Patent Application Laid-Open Publication No. 2009-159683

Patent Document 4: Japanese Patent Application Laid-Open Publication No. 2009-159685

Patent Document 5: Japanese Patent Application Laid-Open Publication No. 2009-159686

Patent Document 6: Japanese Patent Application Laid-Open Publication No. 2011-249229

Patent Document 7: Japanese Patent Application Laid-Open Publication No. 2013-94043

### SUMMARY OF INVENTION

### Technical Problem

When wireless power supply is performed, it is required to improve power transfer efficiency, to thereby transfer more power. Moreover, in the case where the power is transferred by use of a socket, it is desirable that the socket has higher aesthetic design and higher flexibility in the position of power receiving side is provided.

An object of the present invention is, in the case where wireless power supply is performed by the electric field coupling method, to provide a power transmission sheet, etc., capable of improving the power transfer efficiency, achieving higher aesthetic design of a socket, and providing higher flexibility in the position of power receiving side. Further, another object is to provide a power transmission sheet, etc., that is easily subjected to a cutting process in accordance with a shape of a wall surface of an attaching target side.

### Solution to Problem

A power transmission sheet according to the present invention is a power transmission sheet, whose shape is deformable, including an attachment surface adhered to a surface of a substrate and transferring power to a transfer destination device by wireless power supply, and the power transmission sheet includes: an electrode layer in which a first power transfer electrode in a planar shape and a second power transfer electrode in a planar shape are aligned; a transmission circuit that transfers power to the first power transfer electrode and the second power transfer electrode; a covering layer formed on a surface of the substrate, the surface being opposite to the attachment surface as viewed from the electrode layer; and an attachable structure that enables to attach the transfer destination device to cause an electrode surface provided to the transfer destination device to confront the first power transfer electrode and the second power transfer electrode with the covering layer interposed therebetween.

Here, it is preferable that the first power transfer electrode and the second power transfer electrode form an electric field coupling portion with the electrode surface provided to the transfer destination device, and transfer the power to the transfer destination device by action of electrostatic induction generated by application of AC power to the electric field coupling portion as power.

Moreover, it is preferable that plural first power transfer electrodes and plural second power transfer electrodes are aligned in an alternating pattern, and it is preferable that an area of the first power transfer electrode and the second power transfer electrode is 1 cm² to 5000 cm² for each, and space between the adjacent electrodes aligned in an alternating pattern (shortest space between end portions of the respective electrodes) is 0.2 cm to 10 cm.

Moreover, the covering layer may have a structure in which a sheet of a dielectric body and a sheet of a conductive body are laminated in a thickness direction to form plural layers, and the sheets of the conductive body, each of which occupies a different layer, are electrically connected one another.

Then, it is preferable that the covering layer is a covering sheet formed by sandwiching a sheet of a conductive body by sheets of a dielectric body and laminating thereof, and it is preferable that the covering layer has a structure in which a covering sheet formed by sandwiching a sheet of a conductive body by sheets of a dielectric body and laminating thereof is folded.

Further, it is preferable that the electrode surface and the transmission circuit form a structure capable of being cut between the first power transfer electrode and the second power transfer electrode without impairing a function of transferring the power to the transfer destination device.

Moreover, a power supply device according to the present invention includes: a power supply module that generates AC power for transferring power to a transfer destination device by wireless power supply according to an electric field coupling method; and a power transmission sheet, whose shape is deformable, that includes an attachment surface adhered to a surface of a substrate and transfers the power to the transfer destination device, wherein the power transmission sheet includes: an electrode layer in which a first power transfer electrode in a planar shape and a second power transfer electrode in a planar shape are aligned; a transmission circuit that transfers power to the first power transfer electrode and the second power transfer electrode; a covering layer formed on a surface of the substrate, the surface being opposite to the attachment surface as viewed from the electrode layer; and an attachable structure that enables to attach the transfer destination device to cause an electrode surface provided to the transfer destination device to confront the first power transfer electrode and the second power transfer electrode with the covering layer interposed therebetween.

Further, a power transmission system according to the present invention includes: a power supply device including a power supply module that generates AC power for transferring power to a transfer destination device by wireless power supply according to an electric field coupling method, and a power transmission sheet, whose shape is deformable, that includes an attachment surface adhered to a surface of a substrate and transfers the power to the transfer destination device; and a transfer destination device that is able to be attached and detached to and from the power transmission sheet of the power supply device at will, and is able to receive the power from the power transmission sheet when being attached to the power transmission sheet, wherein the power transmission sheet of the power supply device includes: an electrode layer in which a first power transfer electrode in a planar shape and a second power transfer electrode in a planar shape are aligned; a transmission circuit that transfers power to the first power transfer electrode and the second power transfer electrode; a covering layer formed on a surface of the substrate, the surface being opposite to the attachment surface as viewed from the electrode layer; and an attachable structure that enables to attach the transfer destination device to cause an electrode surface provided to the transfer destination device to confront the first power transfer electrode and the second power transfer electrode with the covering layer interposed therebetween.

### Advantageous Effects of Invention

In the case where wireless power supply is performed by the electric field coupling method, it is possible to provide a power transmission sheet, etc., capable of improving the power transfer efficiency, achieving higher aesthetic design of a socket, and providing higher flexibility in the position of power receiving side. Further, it is possible to provide a power transmission sheet, etc., that is easily subjected to a cutting process in accordance with a shape of a wall surface of an attaching target side.

### BRIEF DESCRIPTION OF DRAWINGS

FIG. 1 is an example of a block diagram showing a functional configuration example of a power transmission system to which an exemplary embodiment is applied;

FIG. 2 is a diagram showing an example of a circuit configuration for realizing the power transmission system of FIG. 1;

FIG. 3A is a diagram illustrating an example of specific modes of the power transmission system; FIG. 3B is a diagram in which a plug is viewed from the IIIb direction in FIG. 3A, and is an example of a diagram of the plug as viewed from the direction of attachment to a power transmission sheet;

FIG. 4 is an example of an exploded perspective view showing a configuration of the power transmission sheet;

FIG. 5 is an example of a cross-sectional view of the power transmission sheet and a substrate;

FIG. 6 is an example of a diagram illustrating arrangement of wiring and electrodes;

FIGS. 7A and 7B are examples of diagrams illustrating configurations of a covering layer;

FIG. 8 is an example of a diagram illustrating a method of a cutting process of the power transmission sheet;

FIG. 9 is an example of a diagram illustrating another arrangement of a power supply module, etc.; and

FIG. 10 is an example of a diagram illustrating another arrangement of the electrodes.

### DESCRIPTION OF EMBODIMENTS

### <Description of an Overall Power Transmission System>

Hereinafter, an exemplary embodiment according to the present invention will be described in detail with reference to attached drawings.

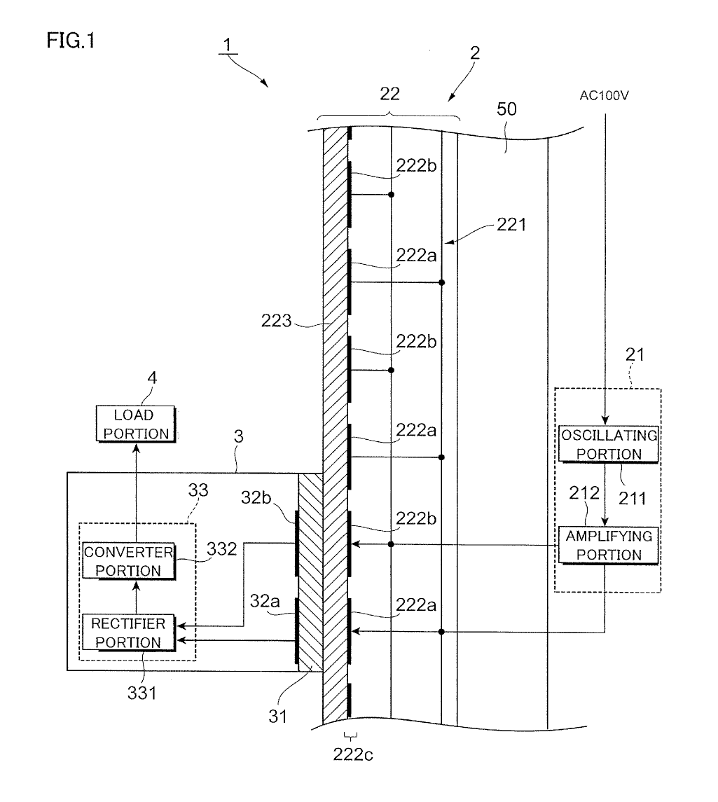

FIG. 1 is an example of a block diagram showing a functional configuration example of a power transmission system to which an exemplary embodiment is applied. Note that, in FIG. 1, of the various functions included in a power transmission system 1, those related to the exemplary embodiment are selected and shown.

The power transmission system 1 of the exemplary embodiment includes, as a device of the power supplying side, a power supply unit 2, which is an example of a power supply device that supplies power. Moreover, as a device of the power receiving side, a plug 3, which is an example of a transmission destination device that receives power supplied from the power supply unit 2, and a load portion 4, which is an example of a power consumption device, are included.

The power supply unit 2 is a device for supplying power to the load portion 4 via the plug 3. In the exemplary embodiment, which is described in detail later, the power supply unit 2 supplies power to the load portion 4 by wireless (non-contact) power supply according to an electric field coupling method.

The power supply unit 2 includes a power supply module 21 that generates AC power for transferring power to the plug 3 by wireless power supply according to the electric field coupling method, and a power transmission sheet 22 that transfers power to the plug 3.

The power supply module 21 includes an oscillating portion 211 that generates high-frequency AC power and an amplifying portion 212 that amplifies the high-frequency AC power.

The power supply module 21 is connected to, for example, a commercial power source, and has a function of converting the power supplied from the commercial power source into power suitable for carrying out the wireless power supply. The commercial power supply is of the AC power and, for example, the voltage is 100V and the frequency is 50 Hz. The power supply module 21 converts the AC power into high-frequency AC power as the power suitable for carrying out the wireless power supply.

The power transmission sheet 22 functions as a socket, and is provided, for example, to configure a wall surface of a building. Moreover, the power transmission sheet 22 includes electrodes 222a and 222b that carry out power supply to the plug 3 by the electric field coupling method, a covering layer 223 that insulates the electrodes 222a and 222b, and a wiring portion 221, which is an example of a transmission circuit that transfers the high-frequency AC power from the power supply module 21 to the electrodes 222a and 222b by wire. Here, the electrodes 222a and 222b and the wiring portion 221 configure an electrode layer 222c. The covering layer 223 which is described in detail later is, for example, in the form of wallpaper, and is able to be cut in accordance with a shape of a wall surface. Note that the electrode 222a functions as a first power transmission electrode of a planar type, and the electrode 222b functions as a second power transmission electrode of a planar type.

The plug 3 is brought into contact with the power transmission sheet 22 of the power supply unit 2, and receives the power supplied from the power supply unit 2. The plug 3 can be detachably attached and detached to and from the power transmission sheet 22 of the power supply unit 2 at will. Then, when the plug 3 is attached to the power transmission sheet 22, it becomes possible to receive the power from the power transmission sheet 22.

Moreover, there is provided a not-shown maintaining means which is described in detail later, for maintaining the contact between the power supply unit 2 and the plug 3 at this time. In addition, there are no significant constraints in positions or directions when the plug 3 is attached to the power supply unit 2, as compared to an electromagnetic induction system to be described later. Then, it is preferable that, when the plug 3 is attached to the power supply unit 2, the power supply unit 2 side detects that the plug 3 is attached, and power supply is automatically started. As a system for detecting that the plug 3 is attached, there have been suggested various types of methods, and any method can be used.

The plug 3 includes a covering layer 31, which is similar to the covering layer 223, electrodes 32a and 32b for receiving the high-frequency AC power according to the electric field coupling method, and a power receiving module 33 that performs adjustment, etc., of the power received by the plug 3.

The power receiving module 33 includes a rectifier portion 331 that converts the high-frequency AC power received by the plug 3 into DC power, and a converter portion 332 that adjusts the voltage of the DC power.

The power receiving module 33 has a function of adjusting the high-frequency AC power or the like received by the plug 3 and converting thereof into the power suitable to be used in the load portion 4. Note that the rectifier portion 331 is not needed for equipment used with AC.

The load portion 4 is a commonly used electrical appliance, such as a smartphone, a tablet device, a mobile phone, a personal computer, a digital camera, a portable battery, an organic electro-luminescence illumination, or a light emitting diode illumination. In other words, an appliance that includes a conventional attachment plug and receives power by being attached to a conventional socket, to thereby operate corresponds to the load portion 4. Moreover, the load portion 4 is not limited to the commonly used electrical appliance, and may be, for example, a power-assisted bicycle or an electrical vehicle.

### <Description of Operations of the Power Transmission System>

Next, operations of the power transmission system 1 will be described.

In the power transmission system 1 of the exemplary embodiment, first, the power supplied from a commercial power source is converted by the oscillating portion 211 in the power supply module 21, to thereby generate high-frequency AC power. In other words, the oscillating portion 211 is configured with an oscillation circuit or the like, and functions as an AC-AC converter. Or, the oscillating portion 211 may be a combination of an AC-DC converter that temporarily converts the power supplied from the commercial power supply into DC power and a DC-AC inverter that converts the DC power into the high-frequency AC power. Moreover, the frequency of the high-frequency AC power generated at this time is, for example, 100 kHz to 20 MHz.

The voltage of the high-frequency AC power generated by the oscillating portion 211 is amplified by the amplifying portion 212. The amplifying portion 212 is able to be realized by, for example, a winding transformer or a piezoelectric transformer.

The electrodes 222a and 222b of the power transmission sheet 22 are paired with the electrodes 32a and 32b of the plug 3, respectively, and an electric field coupling portion for transferring the high-frequency AC power according to the electric field coupling method is configured between the two-pairs of electrodes. That is, with the covering layer 223 and the covering layer 31 interposed therebetween, two pairs of capacitors are formed between the electrode 222a and the electrode 32a, and the electrode 222b and the electrode 32b. Therefore, when AC voltage is applied to these two pairs of capacitors, AC power is transferred by the action of electrostatic induction. Since the electrode 222a and the electrode 32a, and the electrode 222b and the electrode 32b are not in contact with each other, the wireless power supply can be performed.

The covering layer 223 is arranged on the plug 3 side of the electrodes 222a and 222b, to insulate the electrodes 222a and 222b. Moreover, in a similar manner, the covering layer 31 is arranged on the power supply unit 2 side of the electrodes 32a and 32b, to insulate the electrodes 32a and 32b. The covering layer 223 and the covering layer 31 will be described in detail later.

The high-frequency AC power received at the electrodes 32a and 32b of the plug 3 is transferred to the power receiving module 33.

The rectifier portion 331 converts the high-frequency AC power into the DC power. The rectifier portion 331 can be realized by a rectifying circuit or the like.

The converter portion 332 adjusts the voltage of the DC power as the power suitable to the load portion 4, and transfers thereof to the load portion 4. Consequently, it is possible to supply the stable voltage and current to the load portion 4.

Note that it may be possible to arrange a single piece of each of the electrodes 222a and 222b ; however, as shown in FIG. 1, plural pieces may be arranged, and further, it is preferable to align the pieces in an alternating pattern in terms of efficiency in power transmission or availability of high degree of flexibility in the positions of the power receiving side. Then, the wireless power supply is performed by the optimum electrodes 222a and 222b that are determined by the position in which the plug 3 is attached to the load portion 4.

### <Description of Circuit Configuration of the Power Transmission System>

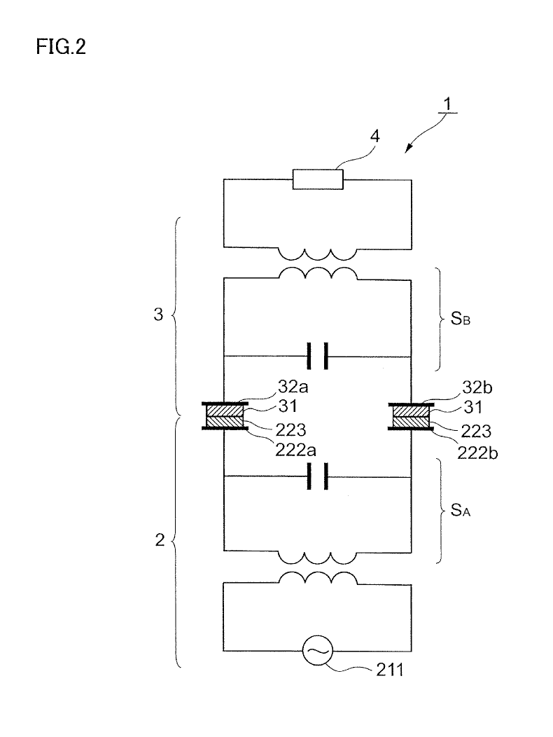

FIG. 2 is a diagram showing an example of a circuit configuration for realizing the power transmission system 1 of FIG. 1.

The circuit configuration shown in the figure is of the so-called parallel resonant type. In the circuit of the parallel resonant type, from the lower side to the upper side in the figure, respective circuits corresponding to the power supply unit 2, the plug 3 and the load portion 4 are arranged.

The high-frequency AC power that is generated by the oscillating portion 211 and reaches the electrodes 222a and 222b is transferred from the electrodes 222a and 222b to the electrodes 32a and 32b of the plug 3 via the covering layer 223 and the covering layer 31 of the plug 3.

The high-frequency AC power received by the electrodes 32a and 32b of the plug 3 is transferred to the load portion 4 by this circuit.

It is possible to improve the power transfer efficiency by providing parallel resonant circuit portions SA and SB as shown in FIG. 2. Moreover, the higher the frequency of the AC power is, the more the power transfer efficiency is improved. Accordingly, in the exemplary embodiment, the high-frequency AC power by the oscillating portion 211 is used.

Moreover, in the circuit of the above-described parallel resonant type, the electric field coupling portion configured with the electrodes 222a and 32a and the electrodes 222b and 32b does not serve as a part of a resonant circuit. Therefore, even if junction capacitance between these electrodes is varied, influence on a resonance frequency is small; accordingly, the circuit is of extremely high impedance. Consequently, there are some characteristics, such as relatively low supply voltage to the covering layer 31 and the covering layer 223, or the like.
In the electric field coupling method used in the above-described power transmission system 1, there are the following characteristics.
(i) As another method for performing the wireless power supply, there is an electromagnetic induction method utilizing electromagnetic induction. The electromagnetic induction method performs power transfer between a power transfer coil and a power receiving coil by use of electromagnetic induction. In this case, for example, if a large power exceeding 50 W is desired to be transferred, the power transfer coil and the power receiving coil increase in size and become heavy in weight. Therefore, particularly, in a case where a power receiving coil is put in a plug, there occurs a problem that the plug increases its size and becomes heavy in weight. Moreover, in the electromagnetic induction method, it is necessary to introduce a magnetic substance as a magnetic path forming member to the device to allow more compact formation of the magnetic path for improving the power transfer efficiency. With respect to the magnetic path forming member, if a large power is desired to be transferred, the member increases in size and becomes heavy in weight.

In contrast, in the case of the electric field coupling method, it is unnecessary to use the coil or the magnetic path forming member, and even if the large power is desired to be transferred, the problem that the plug 3 increases in size or becomes heavy in weight hardly occurs.
(ii) In a comparative evaluation of the power transfer efficiencies between the electric field coupling method and the electromagnetic induction method at, for example, the same frequency (2 MHz), a result that the power transfer efficiency of the electric field coupling method is higher than that of the electromagnetic induction method has been provided. Specifically, the electric field coupling method had higher power transfer efficiency than the electromagnetic induction method by about 10%. Therefore, the electric field coupling method is capable of transferring more power and generating less heat from the equipment.
(iii) Heat is less likely to be generated when a foreign material enters.

In the above-described electromagnetic induction method, when a foreign material, such as a metal, enters between the power transferring coil and the power receiving coil, heat is generated by the action of electromagnetic induction on the foreign material. On the other hand, in the case of the electric field coupling method, even if a foreign material, such as a metal, enters into the electric field coupling portion, heat is hardly generated.
(iv) High degree of flexibility in attachment position of the plug 3 is available (free positioning).

In the electromagnetic induction method, the power transfer efficiency is considerably degraded due to slight displacement between center shafts of the power transferring coil and the power receiving coil. On the other hand, in the case of the electric field coupling method, electric fields on the electrodes 222a and 222b spread isotropically, and accordingly, even though the positions where the electrodes 222a and the electrodes 32a confront each other and the electrodes 222b and the electrodes 32b confront each other (the vertical direction in FIG. 1) are displaced in some degree, troubles in forming induction fields are less likely to occur. Therefore, in the electric field coupling method, the degree of flexibility in attachment position of the plug 3 is higher than in the electromagnetic induction method, and it is more convenient for a user to use the plug 3 and the load portion 4.
(v) There are few restrictions on the electrode shape or the material of the electrodes 222a and 222b and the electrodes 32a and 32b.

As the material of the electrode 222a and the electrode 32a, and the electrode 222b and the electrode 32b, which configure the electric field coupling portion, various kinds of metals, such as copper, iron and aluminum, various kinds of carbon, a conductive polymer, a resin added with a conductive filler, a rubber composite, or the like can be used, and any material can be selected as long as the conductivity is provided. Moreover, as the electrodes 222a and 222b and the electrodes 32a and 32b, a thin electrode of an evaporated-film level may be used and high degree of flexibility of the shape is available, and thereby troubles in being integrated into the plug 3 is less likely to occur, and it is possible to suppress increase in weight of the plug 3.
(vi) Heat generated in the electric field coupling portion is a little.

In the electric field coupling method, since the induced current between the electrodes is used, heat generated in the electrodes 222a and 222b and the electrodes 32a and 32b is a little. Accordingly, a device which is vulnerable to heat, such as a rechargeable battery, is able to be arranged near the electric field coupling portion.

### <Description of Specific Modes of the Power Transmission System>

Next, specific modes of the power transmission system 1 will be described.

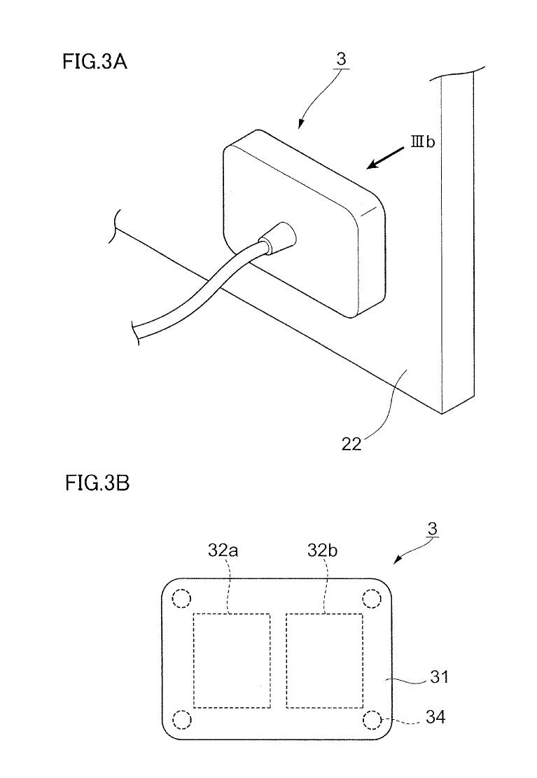

FIG. 3A is a diagram illustrating an example of a specific mode of the power transmission system 1.

In FIG. 3A, with respect to the power transmission system 1, a case in which the plug 3 is attached to the power transmission sheet 22 of the power supply unit 2 is shown, and the load portion 4 is not shown in the figure.

Moreover, FIG. 3B is a diagram in which the plug 3 is viewed from the IIIb direction in FIG. 3A, and is an example of a diagram of the plug 3 as viewed from the direction of attachment to the power transmission sheet 22.

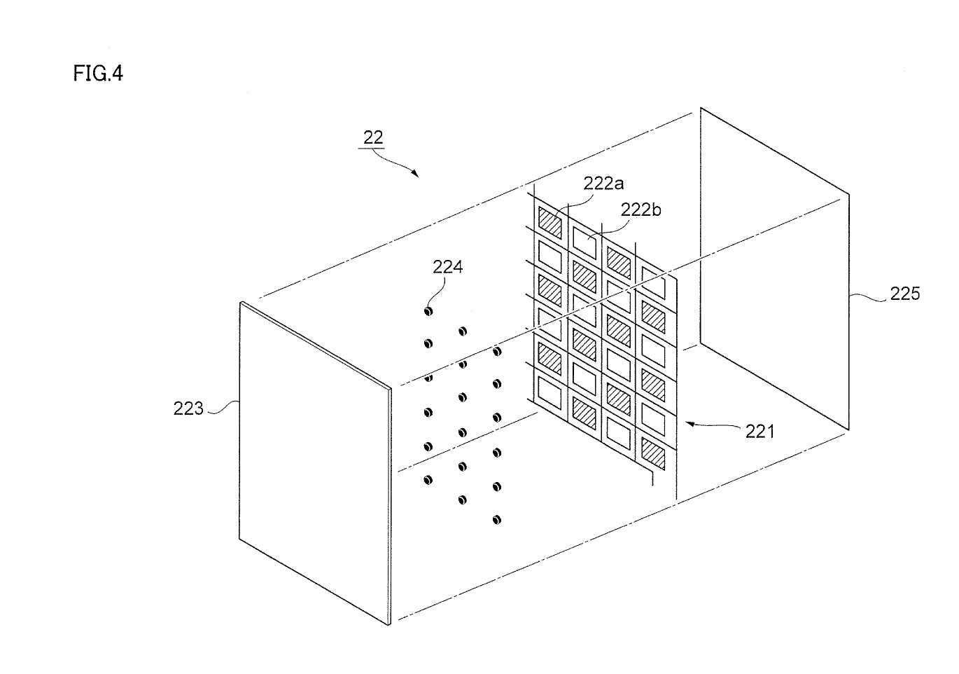

Here, the power transmission sheet 22 configures a wall surface which is a vertical surface, and is able to be attached by the plug 3 as shown in FIG. 3A. Then, in a state in which the plug 3 is attached to the power transmission sheet 22, the covering layer 31 of the plug 3 and the covering layer 223 of the power transmission sheet 22 (for example, shown in FIG. 1 and FIG. 4) are brought into a contact state. Moreover, the electrodes 32a and 32b are in contact with a surface opposite to the surface of the covering layer 31 of the plug 3 which the covering layer 223 contacts, and the electrodes 222a and 222b (refer to FIG. 2) are in contact with a surface opposite to the surface of the power transmission sheet 22 that is in contact with the covering layer 31. Then, the electric field coupling portion is configured between the electrode 32a of the plug 3 and the electrode 222a of the power transmission sheet 22, and between the electrode 32b of the plug 3 and the electrode 222b of the power transmission sheet 22, and thereby the wireless power supply according to the electric field coupling method is performed.

At this time, a maintaining means is required for preventing the plug 3 from falling and maintaining the contact between the plug 3 and the power supply unit 2. In the example shown in FIGS. 3A and 3B, magnets 34 provided to the positions on the covering layer 31, which are around the electrodes 32a and 32b of the plug 3, are used as the maintaining means. The magnets 34 and other magnets, which are provided inside the power transmission sheet 22 and not shown in the figure, attract each other, and accordingly, it is possible to maintain the contact between the plug 3 and the power transmission sheet 22.

Moreover, it is possible to carry out positioning of the plug 3 by adjusting the positions of the magnets provided to the power supply unit 2 side. In the case of the electric field coupling method, as described above, even if the positions of the electrodes configuring the electric field coupling portion are displaced, the power transfer efficiency is less likely to be deteriorated. However, since smaller displacement of positions is preferable, the positions of the magnets provided to the power supply unit 2 side are adjusted, to thereby reduce the displacement of positions of the electrodes.

Note that the maintaining means to attach the plug 3 to the power transmission sheet 22 is not limited to that shown in FIGS. 3A and 3B. For example, each of the plug 3 and the power transmission sheet 22 is provided with magic tape (registered trademark), and the plug 3 may be attached to the power transmission sheet 22 by use of magic tape (registered trademark). Moreover, it is possible to provide suction cups in place of the magnets 34, and to attach the plug 3 to the power transmission sheet 22 by use of pressure differences within and outside the suction cups generated when the suction cups are pressed against the power transmission sheet 22. In addition, it is also possible to use a ferromagnetic material, such as iron or the like, as a conductive sheet, to be described in detail later, inside the covering layer 223, which is a surface of the plug 3 side of the power transmission sheet 22, to thereby attach the plug 3 to the power transmission sheet 22 by use of attractive force between the ferromagnetic material and the magnets 34 provided to the plug 3. In the exemplary embodiment, the configurations as described above can be grasped as an attachable structure that makes it possible to attach the plug 3 so that the electrode 32a of the plug 3 and the electrode 222a of the power transmission sheet 22 confront (face) each other and the electrode 32b of the plug 3 and the electrode 222b of the power transmission sheet 22 confront (face) each other.

However, if any of the methods is employed, it is preferable that air entering between the plug 3 and the power transmission sheet 22 is kept as little as possible, to thereby bring the plug 3 and the power transmission sheet 22 into intimate contact. If air excessively enters between the plug 3 and the power transmission sheet 22, capacitance in the electric field coupling field formed between the electrodes is reduced, and thereby power transferring efficiency is decreased. Therefore, it is preferable that there are asperities as little as possible on the surface of the covering layer 223 on the plug 3 side and the surface of the covering layer 31 of the plug 3 on the power transmission sheet 22 side.

### <Description of Configuration of the Power Transmission Sheet>

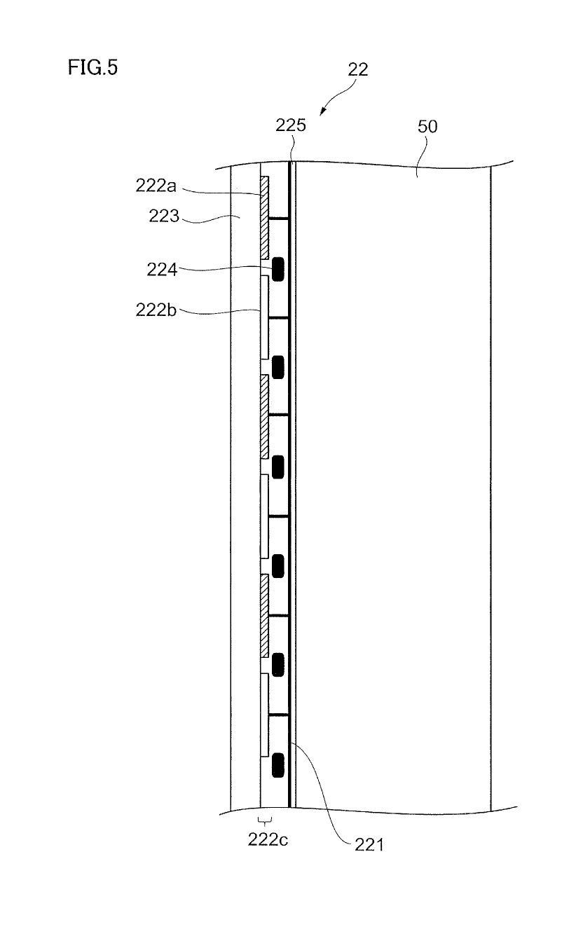

FIG. 4 is an example of an exploded perspective view showing a configuration of the power transmission sheet 22. Moreover, FIG. 5 is an example of a cross-sectional view of the power transmission sheet 22 and a substrate.

As shown in FIG. 5, the power transmission sheet 22 is adhered on the wall portion (substrate) 50, to be thereby bonded. Then, after being attached to the surface of the wall portion 50, power is transferred to the plug 3 according to the wireless power supply. The wall portion 50 is an example of an attaching object to which the power transmission sheet 22 is attached. Note that, as a method of attaching the power transmission sheet 22, other than the method of pasting with a bonding agent, nail fastening, screw fastening, staple fastening or the like may be employed.

The wall portion 50 is a general wall of a building, and a concrete wall, a gypsum-board wall, a wooden wall, a soil wall, a sand coated wall or the like falls under the category. Moreover, the wall portion 50 may be a wall base made of wood or steel, or structural plywood. Further, the wall portion 50 may be a general wall in a state where wallpaper (cloth) or the like is attached thereto.

The power transmission sheet 22 has a structure in which the wiring portion 221, the electrode layer 222c configured with the electrodes 222a and 222b, and the covering layer 223 having been described in FIG. 1 are laminated in the order. Moreover, the power transmission sheet 22 further includes magnets 224 for carrying out registration of the plug 3 with the magnets 34 (refer to FIG. 3B), and a base portion 225 for sandwiching the wiring portion 221 and the electrodes 222a and 222b with the covering layer 223. The base portion 225, the wiring portion 221, the electrodes 222a and 222b, the covering layer 223 and the magnets 224 are adhered to one another by a not-shown bonding agent or the like, to be thereby fastened. Or, it may be possible that the wiring portion 221 and the electrodes 222a and 222b are formed on the base portion 225 by plating or printed wiring, and further, the covering layer 223 and the magnets 224 are adhered one another by a not-shown bonding agent or the like. The base portion 225 functions as an attachment surface for a surface on the wall portion 50 side. Moreover, the base portion 225 may include a not-shown adhesive layer or the like on the surface of the wall portion 50 side for carrying out junction with the wall portion 50. Moreover, in this case, it is possible that the covering layer 223 is formed on a surface side opposite to the base portion 225 as viewed from the electrodes 222a and 222b.

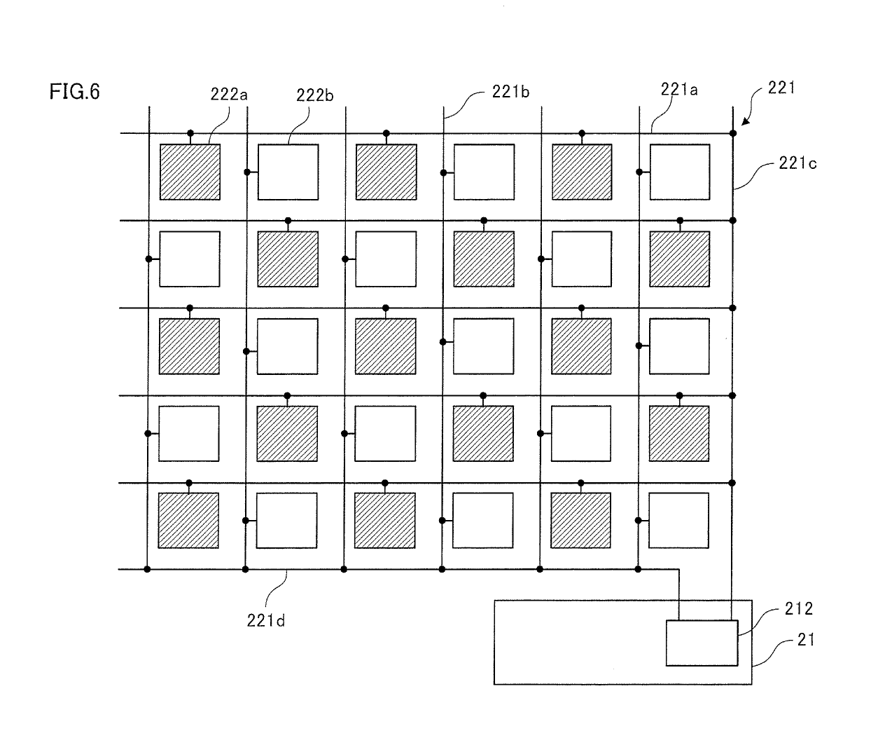

FIG. 6 is an example of a diagram illustrating arrangement of the wiring portion 221 and the electrodes 222a and 222b.

As shown in the figure, the electrodes 222a and 222b form a rectangular shape, and are aligned in a grid-like alternating pattern in the vertical direction and the horizontal direction in the figure. In other words, the electrodes 222a and the electrodes 222b are arranged to form a checkerboard pattern. Note that, in this case, an electrode surface is formed by the electrodes 222a and the electrodes 222b.

By arranging the electrodes 222a and 222b in this manner, in whichever direction the plug 3 is attached to the power transmission sheet 22, any of the electrodes 222a is positioned to confront the electrode 32a of the plug 3 and any of the electrodes 222b is positioned to confront the electrode 32b of the plug 3. Therefore, the degree of flexibility in attachment of the plug 3 is improved. However, as described above, smaller misalignment between the confronting electrodes is preferable from a viewpoint of improvement of the power transfer efficiency. Therefore, from this viewpoint, it is more preferable to perform the above-described alignment by the magnets 34 and the magnets 224.

Moreover, as shown in the figure, plural wirings 221a extending in the horizontal direction in the figure and plural wirings 221b extending in the vertical direction are arranged. The wirings 221a and 221b are arranged between the electrodes 222a and 222b.

The wirings 221a extending in the horizontal direction in the figure are connected to the electrodes 222a that are arranged adjacent to the lower side of the wirings 221a, respectively, and the wirings 221b extending in the vertical direction in the figure are connected to the electrodes 222b that are arranged adjacent to the right side of the wirings 221b, respectively.

Then, the plural wirings 221a connected to the electrodes 222a are connected to a single lead 221c provided to the right end in the figure, and the plural wirings 221b connected to the electrodes 222b are connected to a single lead 221d provided to the lower end in the figure. The leads 221c and 221d are connected to the amplifying portion 212 of the power supply module 21.

In the exemplary embodiment, the wiring portion 221 is configured with the wirings 221a and 221b and the leads 221c and 221d. Then, with the wiring portion 221 configured in this manner, to whichever position in the power transmission sheet 22 the plug 3 is attached, power supply by any of the electrodes 222a and 222b is possible.

Moreover, it is possible to arbitrarily change the size of the electrodes 222a and 222b and the electrodes 32a and 32b of the plug 3 according to the power required by the load portion 4 and the junction capacitance of the power transmission sheet. Further, it is unnecessary that the electrodes 222a and 222b and the electrodes 32a and 32b of the plug 3 are of the same size. For example, the size of the electrodes 222a and 222b and the electrodes 32a and 32b of the plug 3 is preferably 1 cm² to 5000 cm² per one electrode, and more preferably, 10 cm² to 1000 cm². Moreover, a surface occupancy of the electrode surfaces in total in the power transferable region is preferably 40% to 95%, and more preferably, 50% to 70%. Note that the power transferable region refers to a range in which the power can be transferred when the plug 3 is attached to the power transmission sheet 22. Further, space between the adjacent electrodes (the shortest space between end portions of the respective electrodes) is preferably 0.2 cm to 10 cm, and more preferably, 0.2 cm to 5 cm. If the space between the adjacent electrodes is less than 0.2 cm, a short circuit is likely to occur. Moreover, if the space between the adjacent electrodes is more than 10 cm, the receiving appliance (the plug 3) becomes too large.

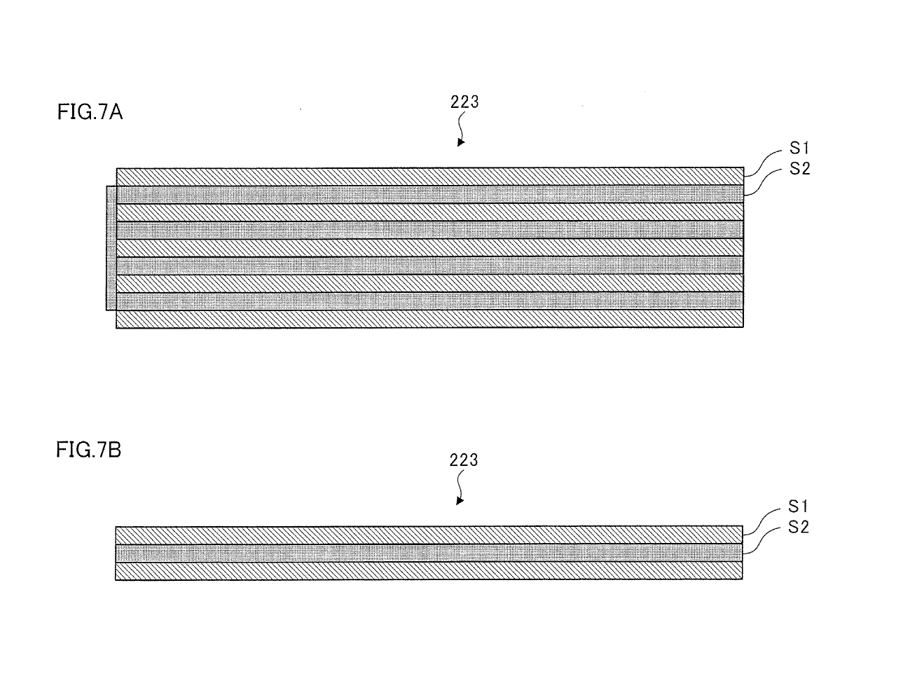

FIGS. 7A and 7B are examples of diagrams illustrating configurations of the covering layer 223. The surfaces of the electrodes 222a and 222b confronting the electrodes 32a and 32b, respectively, are required to be insulated not to cause an electrical shock or the like to a user. Note that the covering layer 31 has a configuration similar to the covering layer 223.

In FIG. 7A, the covering layer 223 shown in the figure has a structure in which sheets S1 of a dielectric body and sheets S2 of a conductive body are laminated in the thickness direction to form plural layers, and the sheets S2, each of which occupies a different layer, are electrically connected with one another. Moreover, at this time, the surface of the covering layer 223 that is brought into contact with the electrodes 222a and 222b, and the surface opposite thereto that configures the front surface of the power transmission sheet 22 and is exposed to the plug 3 side are made of the sheets Si of the dielectric body, and the sheets S2 of the conductive body are arranged inside the covering layer 223.

As a method for electrically connecting the sheets S2 of the conductive body, there are some methods, such as, a method in which a through hole that penetrates the sheets S2 of the conductive body occupying the different layers is formed for forcing thereof into conduction, a method in which an end portion of one side of each of the plural sheets S2 of the conductive body is bent to be brought into contact with the other sheets S2 of the conductive body, and a method in which the sheets S2 of the conductive body are folded to be used.

As the sheet S1 of the dielectric body, for example, a sheet with an insulating property containing a capacitive component, such as rubber or resin, is provided, and a bonding agent or an anchor coat is included therein; however, the sheet S1 is not particularly limited thereto.

As the sheet S2 of the conductive body, there is no particular limitation as long as the material has conductivity; however, examples include a sheet using a metal, such as gold, silver, copper, aluminum or iron, conductive oxide, such as ITO (Indium Tin Oxide), conductive polymer, conductive rubber such as conductive filler composite rubber or the like, and a composite thereof or the like. Moreover, in regard to the shape of the sheet S2 of the conductive body, a plate shape, a sheet shape, a film shape or a film shape formed by sputtering, vapor deposition, plating or the like is able to be appropriately selected in accordance with a target thickness.

In FIG. 7B, the covering layer 223 shown in the figure has a structure in which a pair of sheets S1 of the dielectric body sandwiches the sheet S2 of the conductive body to be laminated in the thickness direction. At this time, the surface of the covering layer 223 that is brought into contact with the electrodes 222a and 222b, and the surface opposite thereto, which is the front surface of the power transmission sheet 22, are configured by the sheets S1.

Further, as another example of the configuration of the covering layer 223, there is a method in which, as shown in FIG. 7B, a covering sheet sandwiching the sheet S2 of the conductive body by the sheets S1 of the dielectric body and laminating thereof is folded and used.

From the viewpoint of strength or easy productivity of the covering layer 223, the method in which a covering sheet sandwiching the sheet S2 of the conductive body by the sheets S1 of the dielectric body is folded and used is preferred.

The capacitance of the covering layer 223 and the covering layer 31 (that is, the junction capacitance between the electrodes) is junction capacitance formed by the electrodes 222a and 222b, electrodes 32a and 32b, and the covering layers 31 and 223 for transferring and receiving power by the electric field coupling method. Specifically, the capacitance of the covering layer 223 and the covering layer 31 is determined by the capacitance of the sheet S1 of the dielectric body that is in touch with the electrodes 222a and 222b and the electrodes 32a and 32b. In other words, the capacitance is determined by the capacitance for the two sheets S1 of the dielectric body at locations in contact therewith. The smaller the thickness of the sheet S1 of the dielectric body is, the larger the capacitance becomes.

If the sheets S2 of the conductive body are not electrically connected at this time, the sheets S2 of the conductive body are laminated independently from each other; accordingly, a series capacitor is formed by the sheets of the conductive body. In this case, with increase in the number of laminated sheets, the capacitance becomes significantly small.

The power transmission sheet 22 is able to set up a socket to the wall portion 50 with a simpler configuration. In other words, the power transmission sheet 22 is able to be attached by only carrying out connection to the wall portion 50 by pasting or the like as a wall surface, and after the connection is carried out, it is sufficient to be electrically connected to the power supply module 21 by use of the leads 221c and 221d ; therefore, complicated electrical work is unnecessary.

Moreover, since the power transmission sheet 22 has flexibility, the shape thereof can be deformed before attachment to the wall portion 50. Therefore, it is possible to roll up the sheet to be conveyed, and excellence in handling is provided. Further, even though the wall portion 50 is a quadric surface, the sheet can be adhered in accordance therewith.

Further, the surface of the power transmission sheet 22 on the plug 3 side is the covering layer 223, and accordingly, it is unnecessary to provide hole parts or the like as in the conventional socket. Therefore, by using the power transmission sheet 22 of the exemplary embodiment, it is possible to form a wall surface with excellent aesthetic design. Moreover, since there is no hole part, it is less likely that water or dust enters inside the power transmission sheet 22 and shorts or the like occur; therefore, a higher level of safety is available (for example, it is less likely that a fire occurs due to tracking, or an electrical shock is caused by finger insertion by a baby, infant or pet). Further, as described above, the degree of flexibility in the position of the plug 3 on the power receiving side is higher as compared to the conventional socket.

Still further, there is also a characteristic point that the cutting process is easily performed in accordance with a shape of a wall surface.

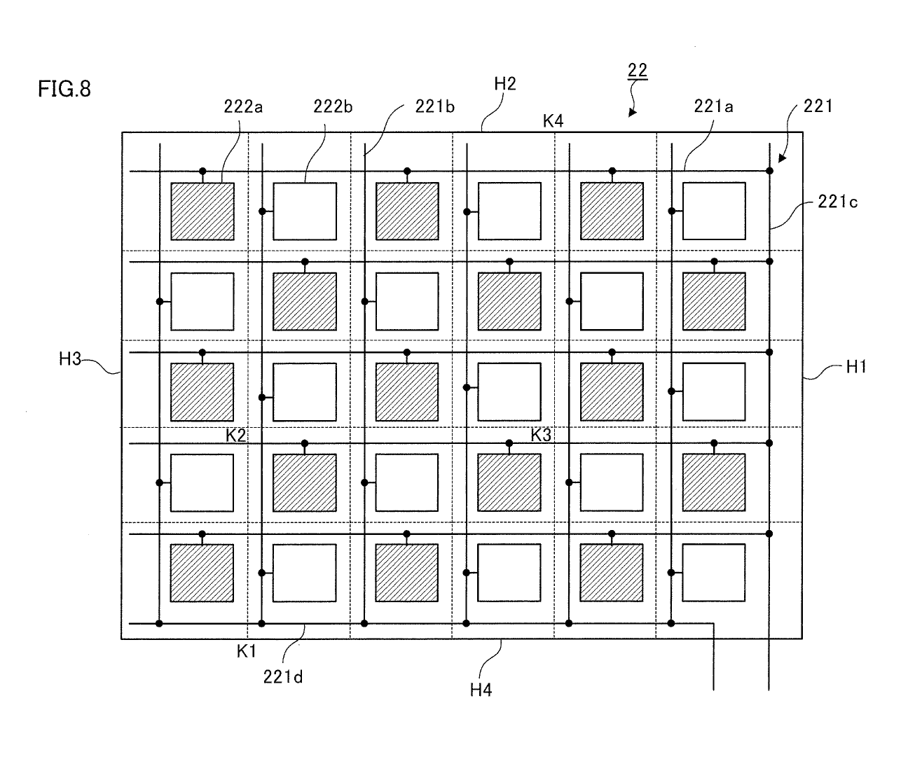

FIG. 8 is an example of a diagram illustrating a method of a cutting process of the power transmission sheet 22.

Here, it is assumed that the power transmission sheet 22 before cutting has a rectangular shape, and the four sides are assumed to be H1, H2, H3 and H4.

The locations able to be cut at this time are those indicated by dotted lines between the electrodes 222a and 222b. In other words, it is only necessary to determine the electrodes 222a and 222b to be used in accordance with the shape of the wall surface, and to cut the power transmission sheet 22 to preserve the wirings 221a and 221b connected to the electrodes 222a and 222b, and the leads 221c and 221d. To take an example, it is possible to cut the power transmission sheet 22 along the dotted lines connecting K1, K2, K3 and K4. Then, in case the power transmission sheet 22 after being cut includes side portions H1 and H4 in which the lead 221c and the lead 221d exist, it is possible to be connected to the power supply module 21; therefore, a trouble in power supply to the plug 3 hardly occurs. By providing a structure in which the electrodes 222a and the electrodes 222b are aligned in the grid-like alternating pattern and the wirings 221a and 221b are placed between the electrodes 222a and 222b, the power transmission sheet 22 is able to be cut between the electrodes 222a and the electrodes 222b without impairing the function of transferring power to the plug 3. Note that, for realizing this item, the configuration is not limited to the one shown in FIG. 8; for example, the wirings 221a and 221b are arranged on the surface side opposite to the covering layer 223 as viewed from the electrodes 222a and 222b (for example, the wirings 221a and 221b are arranged at the positions on the back side of the electrodes 222a and 222b in FIG. 8, and at the positions on the right side of the electrodes 222a and 222b in FIG. 5).

In this manner, the power transmission sheet 22 of the exemplary embodiment is easily subjected to the cutting process in accordance with the shape of the wall surface, and is excellent in workability.

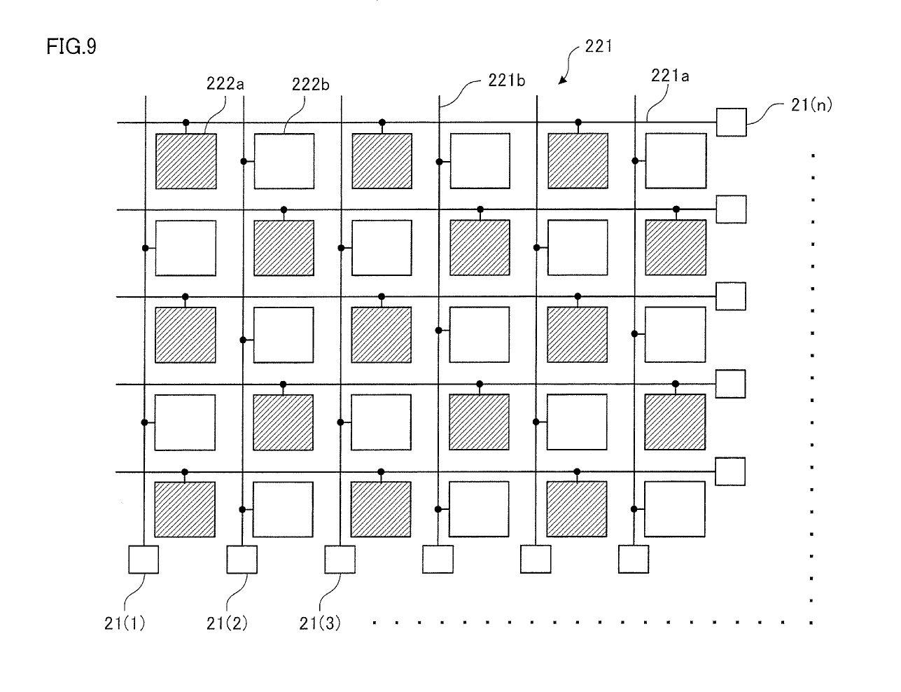

Note that, though there was a single power supply module 21 in the example described in detail above, the location or the number of the power supply module 21 may be changed as shown in FIG. 9, and thereby, it becomes possible to selectively supply power to a position of a detected load. In the example shown in FIG. 9, it is assumed that the number of the power supply module 21 is n, and each of the power supply modules 21 is illustrated as the power supply module 21 (k) (where k=1, 2, 3, . . . , n). Then, each power supply module 21 is connected to the wirings 221a or the wirings 221b.

Moreover, the electrodes 222a and 222b of the power transmission sheet 22 have the rectangular shape as shown in FIG. 6; however, the shape are not limited thereto, and there may be other shapes, such as, for example, triangular, hexagonal, circular and the like.

Further, the electrodes 222a and 222b have been arranged in a grid-like pattern; however, arrangement is not limited thereto.

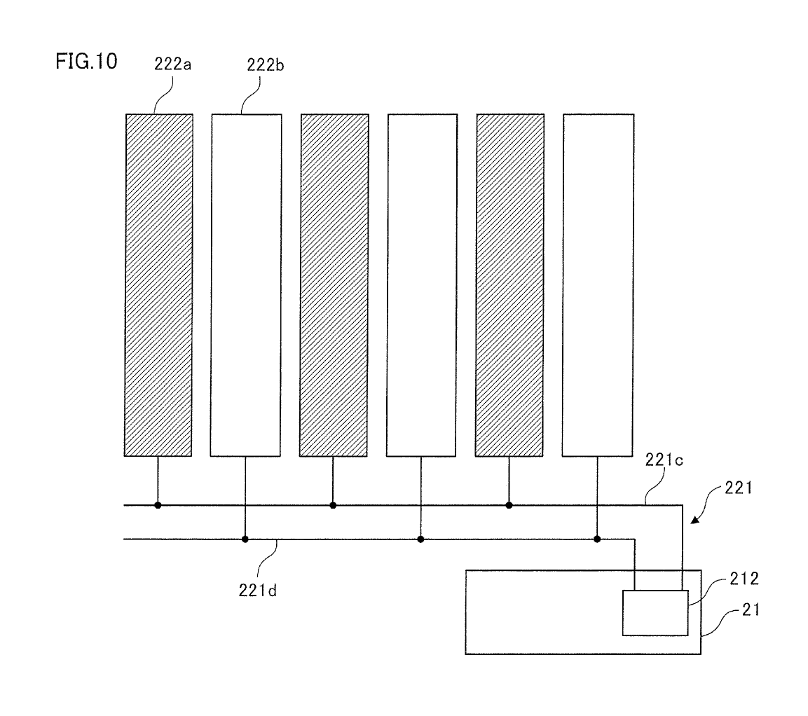

FIG. 10 is an example of a diagram illustrating another arrangement of the electrodes 222a and 222b.

As shown in the figure, the electrodes 222a and 222b form a rectangular shape, and are aligned in an alternating pattern in the vertical direction. In other words, the electrodes 222a and the electrodes 222b are arranged in a blind-like pattern. Moreover, the electrodes 222a are connected to the lead 221c and the electrodes 222b are connected to the lead 221d. The leads 221c and 221d are connected to the amplifying portion 212 of the power supply module 21.

If the electrodes 32a and 32b of the plug 3 are arranged to confront the electrodes 222a and 222b, respectively, the electrodes 222a and 222b even in such arrangement are able to supply power to the plug 3. In this case, since the structures of the electrodes 222a, 222b and the wiring portion 221 become simpler, it is possible to manufacture the power transmission sheet 22 at lower cost. However, the degree of flexibility of the position of the plug 3 is higher in the case of FIG. 6.

Note that, as the arrangement of the electrodes 222a and 222b other than this, a mode in which the electrodes 222a and 222b having the shape shown in FIG. 6 are arranged in a staggered alternating pattern is considered.

Moreover, in the example described in detail above, the power transmission sheet 22 configured a wall surface; however, the present invention is not limited thereto, and the power transmission sheet 22 may form, for example, a floor surface or a ceiling surface. In addition, the power transmission sheet 22 may be a top panel of a table, desk, a shoe cupboard or the like.

Hitherto, for convenience of description, the parallel resonant circuit has been described; however, the present invention is not limited thereto, and the power transmission sheet, the power supply device and the power transmission system even by the so-called series resonant circuit are effectively used.

### REFERENCE SIGNS LIST

1 Power transmission system
2 Power supply unit
3 Plug
4 Load portion
21 Power supply module
22 Power transmission sheet
31, 223 Covering layer
32a, 32b, 222a, 222b Electrode
33 Power receiving module
34, 224 Magnet
50 Substrate (Wall portion)
221 Wiring portion
222c Electrode layer
225 Base portion

1. A power transmission sheet including an attachment surface adhered to a surface of a substrate and transferring power to a transfer destination device by wireless power supply, the power transmission sheet, whose shape is deformable, comprising:
an electrode layer in which a first power transfer electrode in a planar shape and a second power transfer electrode in a planar shape are aligned;
a transmission circuit that transfers power to the first power transfer electrode and the second power transfer electrode;
a covering layer formed on a surface of the substrate, the surface being opposite to the attachment surface as viewed from the electrode layer; and
an attachable structure that enables to attach the transfer destination device to cause an electrode surface provided to the transfer destination device to confront the first power transfer electrode and the second power transfer electrode with the covering layer interposed therebetween.

2. The power transmission sheet according to claim 1, wherein the first power transfer electrode and the second power transfer electrode form an electric field coupling portion with the electrode surface provided to the transfer destination device, and transfer the power to the transfer destination device by action of electrostatic induction generated by application of AC power to the electric field coupling portion as power.

3. The power transmission sheet according to claim 1, wherein a plurality of the first power transfer electrodes and a plurality of the second power transfer electrodes are aligned in an alternating pattern.

4. The power transmission sheet according to claim 1, wherein an area of the first power transfer electrode and the second power transfer electrode is 1 cm² to 5000 cm² for each, and space between the adjacent electrodes aligned in an alternating pattern (shortest space between end portions of the respective electrodes) is 0.2 cm to 10 cm.

5. The power transmission sheet according to claim 1, wherein the covering layer has a structure in which a sheet of a dielectric body and a sheet of a conductive body are laminated in a thickness direction to form a plurality of layers, and the sheets of the conductive body, each of which occupies a different layer, are electrically connected one another.

6. The power transmission sheet according to claim 1, wherein the covering layer is a covering sheet formed by sandwiching a sheet of a conductive body by sheets of a dielectric body and laminating thereof.

7. The power transmission sheet according to claim 1, wherein the covering layer has a structure in which a covering sheet formed by sandwiching a sheet of a conductive body by sheets of a dielectric body and laminating thereof is folded.

8. The power transmission sheet according to claim 1, wherein the electrode surface and the transmission circuit form a structure capable of being cut between the first power transfer electrode and the second power transfer electrode without impairing a function of transferring the power to the transfer destination device.

9. A power supply device comprising:
a power supply module that generates AC power for transferring power to a transfer destination device by wireless power supply according to an electric field coupling method; and
a power transmission sheet, whose shape is deformable, that includes an attachment surface adhered to a surface of a substrate and transfers the power to the transfer destination device,
wherein the power transmission sheet comprises:
an electrode layer in which a first power transfer electrode in a planar shape and a second power transfer electrode in a planar shape are aligned;
a transmission circuit that transfers power to the first power transfer electrode and the second power transfer electrode;
a covering layer formed on a surface of the substrate, the surface being opposite to the attachment surface as viewed from the electrode layer; and
an attachable structure that enables to attach the transfer destination device to cause an electrode surface provided to the transfer destination device to confront the first power transfer electrode and the second power transfer electrode with the covering layer interposed therebetween.

10. A power transmission system comprising:
a power supply device comprising a power supply module that generates AC power for transferring power to a transfer destination device by wireless power supply according to an electric field coupling method, and a power transmission sheet, whose shape is deformable, that includes an attachment surface adhered to a surface of a substrate and transfers the power to the transfer destination device; and
a transfer destination device that is able to be attached and detached to and from the power transmission sheet of the power supply device at will and is able to receive the power from the power transmission sheet when being attached to the power transmission sheet,
wherein the power transmission sheet of the power supply device comprises:
an electrode layer in which a first power transfer electrode in a planar shape and a second power transfer electrode in a planar shape are aligned;
a transmission circuit that transfers power to the first power transfer electrode and the second power transfer electrode;
a covering layer formed on a surface of the substrate, the surface being opposite to the attachment surface as viewed from the electrode layer; and
an attachable structure that enables to attach the transfer destination device to cause an electrode surface provided to the transfer destination device to confront the first power transfer electrode and the second power transfer electrode with the covering layer interposed therebetween.
